(19) United States
(12) Patent Application Publication
(10) Pub. No.: US 2016/0092219 A1
(43) Pub. Date: Mar. 31, 2016

(54) ACCELERATING CONSTANT VALUE GENERATION USING A COMPUTED CONSTANTS TABLE, AND RELATED CIRCUITS, METHODS, AND COMPUTER-READABLE MEDIA

(71) Applicant: QUALCOMM Incorporated, San Diego, CA (US)

(72) Inventor: Michael William Morrow, Wilkes Barre, PA (US)

(21) Appl. No.: 14/499,764

(22) Filed: Sep. 29, 2014

(51) Int. Cl. G06F 9/30; G06F 9/34

(52) U.S. Cl. CPC G06F 9/30043; G06F 9/3001; G06F 9/34

(57) ABSTRACT

Accelerating constant value generation using a computed constants table, and related circuits, methods, and computer-readable media are disclosed. In one aspect, an instruction processing circuit provides a computed constants table containing one or more entries each comprising an address and a constant value. The instruction processing circuit is configured to detect, in an instruction stream, a constant-generating instruction sequence, and to determine whether an address of the constant-generating instruction sequence is present in an entry of the computed constants table. If the address of the constant-generating instruction sequence is present in the entry of the computed constants table, the instruction processing circuit provides a constant value stored in the entry for execution of at least one dependent instruction on the constant-generating instruction sequence. In this manner, the generation of constant values by a constant-generating instruction sequence may be accelerated, allowing dependent instructions to use the constant values with zero-cycle latency.

### BACKGROUND

I. Field of the Disclosure

The technology of the disclosure relates generally to generating constant values during execution of a computer program by a processor.

II. Background

A conventional computer architecture may specify a number of bits (e.g., 32 bits or 64 bits, as non-limiting examples) that indicate a maximum size for data units, memory addresses, and instructions that are supported by the computer architecture. Arithmetic and other operations provided by the computer architecture may thus enable the generation and use of large constant values that approach or reach the maximum size supported. For instance, a 32-bit computer architecture may support the use of large constant values having up to 32 bits, while a 64-bit architecture may enable the use of large constant values of up to 64 bits.

However, generation of large constant values may present challenges in conventional computer architectures. For example, a computer processor implemented according to a conventional computer architecture may be unable to encode large constant values in a single instruction. As a result, the use of alternate techniques may be required to encode large constant values. These techniques may include the use of a constant-generating instruction sequence comprising one or more constant-generating instructions. The one or more constant-generating instructions may carry out a literal load from a memory, may incorporate relative addressing based on a program counter (PC) plus an offset value, and/or may comprise a series of arithmetic logic unit (ALU) operations, as non-limiting examples. One example of a constant-generating instruction sequence for encoding a large constant value using a PC plus an offset value is illustrated below:

ADRP R₀, #4; Register R₀ is loaded with a value from a memory location specified by the PC plus the value four (4) shifted left 12 times (4<<12).

ADD R₀, #0x33; The value in register R₀ is summed with the hexadecimal value 0x33, which is then stored in the register R₀. The register R₀ now contains the desired constant value.

Even in aspects in which a conventional computer architecture permits a large constant value to be encoded in a single constant-generating instruction, the constant-generating instruction may still require one or more processor cycles to execute. As a result, a dependent instruction that is fetched subsequent to the constant-generating instruction sequence, and that uses the generated constant value as an input, may suffer a latency of one or more processor cycles before the dependent instruction may execute. Accordingly, it is desirable to reduce the processor cycle latency incurred through use of constant-generating instruction sequences of one or more constant-generating instructions.

### SUMMARY OF THE DISCLOSURE

Aspects disclosed in the detailed description include accelerating constant value generation using a computed constants table. Related circuits, methods, and computer-readable media are also disclosed. In this regard, in one aspect, an instruction processing circuit is provided. The instruction processing circuit is configured to detect, in an instruction stream, a constant-generating instruction sequence. The instruction processing circuit is further configured to determine whether an address of the constant-generating instruction sequence is present in an entry of a computed constants table. The instruction processing circuit is also configured to, responsive to determining that the address of the constant-generating instruction sequence is present in the entry of the computed constants table, provide a constant value stored in the entry for execution of at least one dependent instruction on the constant-generating instruction sequence. In this manner, the generation of constant values by a constant-generating instruction or instruction sequence may be accelerated, allowing dependent instructions to use constant values with zero-cycle latency. In some aspects, the instruction processing circuit may employ one or more state machines to detect a plurality of constant-generating instructions of the constant-generating instruction sequence. Each state machine may be configured to recognize, e.g., a predetermined set of arithmetic logic unit (ALU) operations. If the constant-generating instruction sequence is detected, the instruction processing circuit may determine a last instruction address of a last instruction from among the plurality of constant-generating instructions as the address of the constant-generating instruction sequence.

In another aspect, a method of accelerating generation of constant values is provided. The method comprises detecting, in an instruction stream, a constant-generating instruction sequence. The method further comprises determining whether an address of the constant-generating instruction sequence is present in an entry of a computed constants table. The method also comprises, responsive to determining that the address of the constant-generating instruction sequence is present in the entry of the computed constants table, providing a constant value stored in the entry for execution of at least one dependent instruction on the constant-generating instruction sequence.

In another aspect, a non-transitory computer-readable medium is provided, having stored thereon computer-executable instructions to cause a processor to detect, in an instruction stream, a constant-generating instruction sequence. The computer-executable instructions stored thereon further cause the processor to determine whether an address of the constant-generating instruction sequence is present in an entry of a computed constants table. The computer-executable instructions stored thereon also cause the processor to, responsive to determining that the address of the constant-generating instruction sequence is present in the entry of the computed constants table, provide a constant value stored in the entry for execution of at least one dependent instruction on the constant-generating instruction sequence.

### BRIEF DESCRIPTION OF THE FIGURES

FIG. 1 is a block diagram of an exemplary computer processor including an instruction processing circuit for accelerating constant value generation using a computed constants table;

FIGS. 2A and 2B illustrate exemplary communications flows for establishing an entry in the computed constants table of FIG. 1 based on a single constant-generating instruction, and providing a constant value from the entry to a dependent instruction by the instruction processing circuit of FIG. 1;

FIGS. 3A and 3B illustrate exemplary communications flows for establishing an entry in the computed constants table of FIG. 1 based on a plurality of constant-generating instructions, and providing a constant value from the entry to a dependent instruction by the instruction processing circuit of FIG. 1;

FIG. 4 is a flowchart illustrating exemplary operations for accelerating constant value generation using the computed constants table of the instruction processing circuit of FIG. 1;

FIG. 5 is a flowchart illustrating exemplary operations for detecting a constant-generating instruction sequence in some aspects of the instruction processing circuit of FIG. 1; and

FIG. 6 is a block diagram of an exemplary processor-based system that can include the instruction processing circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include accelerating constant value generation using a computed constants table. Related circuits, methods, and computer-readable media are also disclosed. In this regard, in one aspect, an instruction processing circuit is provided. The instruction processing circuit is configured to detect, in an instruction stream, a constant-generating instruction sequence. The instruction processing circuit is further configured to determine whether an address of the constant-generating instruction sequence is present in an entry of a computed constants table. The instruction processing circuit is also configured to, responsive to determining that the address of the constant-generating instruction sequence is present in the entry of the computed constants table, provide a constant value stored in the entry for execution of at least one dependent instruction on the constant-generating instruction sequence. In this manner, the generation of constant values by a constant-generating instruction or instruction sequence may be accelerated, allowing dependent instructions to use constant values with zero-cycle latency. In some aspects, the instruction processing circuit may employ one or more state machines to detect a plurality of constant-generating instructions of the constant-generating instruction sequence. Each state machine may be configured to recognize, e.g., a predetermined set of arithmetic logic unit (ALU) operations. If the constant-generating instruction sequence is detected, the instruction processing circuit may determine a last instruction address of a last instruction from among the plurality of constant-generating instructions as the address of the constant-generating instruction sequence.

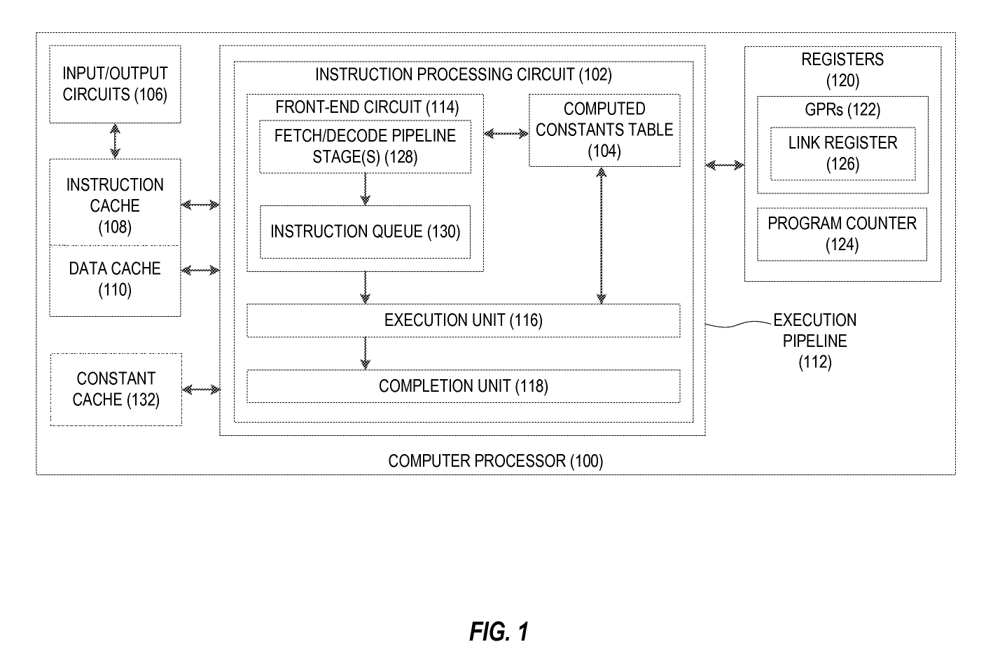

In this regard, FIG. 1 is a block diagram of an exemplary computer processor 100. The computer processor 100 includes an instruction processing circuit 102 providing a computed constants table 104 for accelerating generation of constant values, as disclosed herein. The computer processor 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The computer processor 100 includes input/output circuits 106, an instruction cache 108, and a data cache 110. The computer processor 100 further comprises an execution pipeline 112, which includes a front-end circuit 114, an execution unit 116, and a completion unit 118. The computer processor 100 additionally includes registers 120, which comprise one or more general purpose registers (GPRs) 122, a program counter 124, and a link register 126. In some aspects, such as those employing the ARM® ARM7™ architecture, the link register 126 is one of the GPRs 122, as shown in FIG. 1. Alternately, some aspects, such as those utilizing the IBM® PowerPC® architecture, may provide that the link register 126 is separate from the GPRs 122 (not shown).

In exemplary operation, the front-end circuit 114 of the execution pipeline 112 fetches instructions (not shown) from the instruction cache 108, which in some aspects may be an on-chip Level 1 (L1) cache, as a non-limiting example. The fetched instructions are decoded by the front-end circuit 114 and issued to the execution unit 116. The execution unit 116 executes the issued instructions, and the completion unit 118 retires the executed instructions. In some aspects, the completion unit 118 may comprise a write-back mechanism (not shown) that stores the execution results in one or more of the registers 120. It is to be understood that the execution unit 116 and/or the completion unit 118 may each comprise one or more sequential pipeline stages. In the example of FIG. 1, the front-end circuit 114 comprises one or more fetch/decode pipeline stages 128, which enable multiple instructions to be fetched and decoded concurrently. An instruction queue 130 for holding the fetched instructions pending dispatch to the execution unit 116 is communicatively coupled to one or more of the fetch/decode pipeline stages 128.

Some aspects of the computer processor 100 of FIG. 1 may provide an optional constant cache 132 that is communicatively coupled to one or more elements of the execution pipeline 112. The constant cache 132 may provide a quick-access mechanism by which a value previously stored in one of the registers 120 may be provided to an instruction that uses the value as an input operand. The constant cache 132 may thus improve the performance of the computer processor 100 by providing access to stored values more quickly than the registers 120.

While processing instructions in the execution pipeline 112, the instruction processing circuit 102 may fetch and execute a constant-generating instruction sequence (not shown) comprising one or more constant-generating instructions (not shown). The constant-generating instruction sequence may generate a constant value for loading into one of the registers 120. However, the constant-generating instruction sequence may require one or more processor cycles to generate the constant value. As a result, the instruction processing circuit 102 may be unable to dispatch a subsequent dependent instruction (not shown) until the one or more processor cycles required by the constant-generating instruction sequence has elapsed.

In this regard, the instruction processing circuit 102 of FIG. 1 provides the computed constants table 104 for accelerating constant value generation by constant-generating instruction sequences, and providing constant values to dependent instructions. The instruction processing circuit 102 is configured to detect a constant-generating instruction sequence (not shown) in an instruction stream (not shown) being processed within the execution pipeline 112. In some aspects, the instruction processing circuit 102 may be configured to detect the constant-generating instruction sequence using one or more state machines (not shown). As non-limiting examples, the constant-generating instruction sequence may be detected as a single constant-generating instruction, or as a plurality of constant-generating instructions such as a predetermined set of ALU operations.

As the constant-generating instruction sequence is fetched by the front-end circuit 114 of the instruction processing circuit 102, the instruction processing circuit 102 consults the computed constants table 104, which contains one or more entries (not shown). Each entry may include an address of a previously-detected constant-generating instruction sequence, and a constant value that was previously generated by the constant-generating instruction sequence corresponding to the address. According to some aspects in which the constant-generating instruction sequence is a plurality of constant-generating instructions, the address may correspond to a last instruction address of a last instruction from among a plurality of constant-generating instructions.

The instruction processing circuit 102 determines whether an address of the constant-generating instruction sequence being fetched is present in an entry of the computed constants table 104. If the address of the constant-generating instruction sequence is found (i.e., a “hit”), the instruction processing circuit 102 provides the constant value from the entry to at least one dependent instruction. In aspects wherein the computer processor 100 includes the optional constant cache 132, the constant value may be provided to the at least one dependent instruction via the constant cache 132 (e.g., by writing the constant value to the constant cache 132). In this manner, the at least one dependent instruction may obtain the constant value for the constant-generating instruction sequence without incurring wasted processor cycles.

According to some aspects disclosed herein, if the instruction processing circuit 102 detects a constant-generating instruction sequence but does not find the address of the constant-generating instruction sequence in an entry of the computed constants table 104, a “miss” occurs. In this case, the instruction processing circuit 102 may generate an entry in the computed constants table 104 corresponding to the constant-generating instruction sequence upon execution of the constant-generating instruction sequence. The generated entry includes the address of the constant-generating instruction sequence, and stores the constant value generated by the constant-generating instruction sequence as the constant value of the entry. Accordingly, if and when the constant-generating instruction sequence is again detected by the instruction processing circuit 102, a “hit” in the computed constants table 104 may occur, and the constant value may be provided to a dependent instruction.

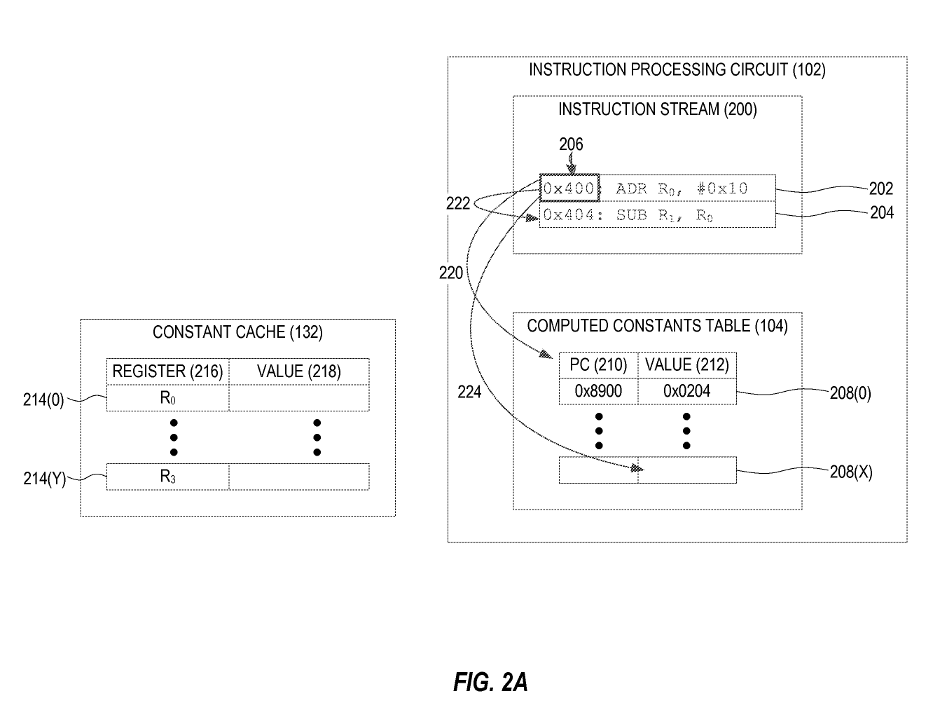

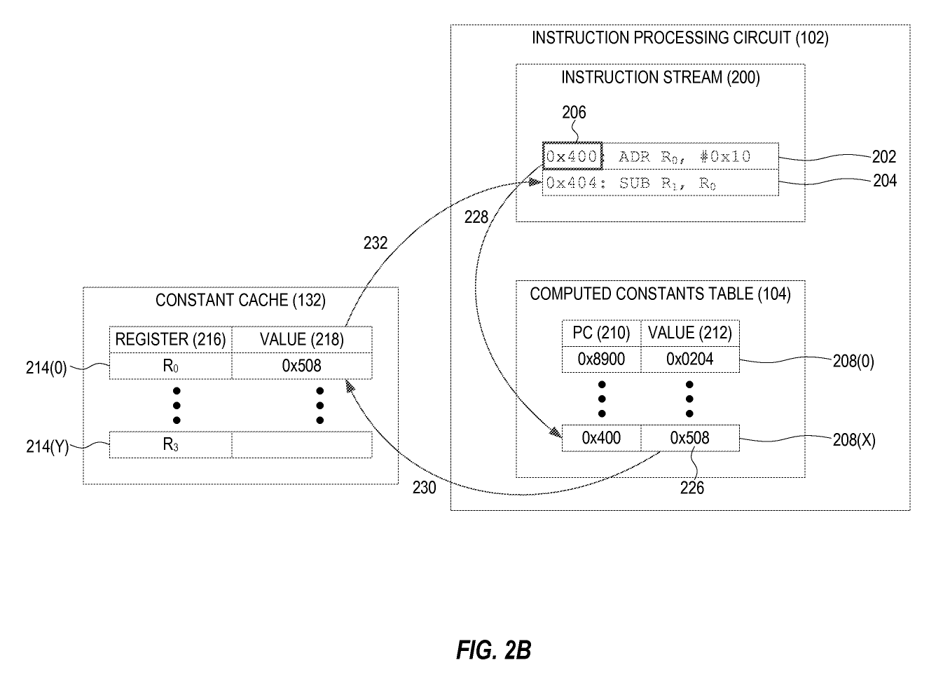

To better illustrate exemplary communications flows of the instruction processing circuit 102 of FIG. 1, FIGS. 2A and 2B are provided. FIG. 2A illustrates exemplary communications flows for establishing an entry in the computed constants table 104 based on a single constant-generating instruction, while FIG. 2B shows exemplary communications flows for providing a constant value of the entry to a dependent instruction. For the sake of clarity, elements of FIG. 1 are referenced in describing FIGS. 2A and 2B.

In FIGS. 2A and 2B, the instruction processing circuit 102 processes an instruction stream 200 comprising two instructions: a constant-generating instruction sequence 202 having a single constant-generating instruction, followed by a dependent instruction 204. The constant-generating instruction sequence 202 is associated with an address 206, which in this example is the hexadecimal value 0x400. It is to be understood that, in some aspects, the address 206 may be retrieved from, e.g., the program counter 124 of FIG. 1. It is to be further understood that, while the constant-generating instruction sequence 202 and the dependent instruction 204 are shown in FIGS. 2A and 2B as occurring consecutively within the instruction stream 200, some aspects may provide that the constant-generating instruction sequence 202 and the dependent instruction 204 may be separated in the instruction stream 200 by intervening instructions (not shown).

The constant-generating instruction sequence 202 in this example is an ADR instruction, which directs the computer processor 100 to load a constant value from an address specified by a current value of the program counter (PC) 124 plus the hexadecimal value 0x10. The constant value is then stored in a register R₀, which may be one of the registers 120 of FIG. 1, as a non-limiting example. The dependent instruction 204 follows the constant-generating instruction sequence 202 in the instruction stream 200, which in this example is a SUB instruction. The dependent instruction 204 receives the constant value stored in the register R₀ as an input, and subtracts it from a value stored in a register R₁ (e.g., another one of the registers 120 of FIG. 1). The result is then stored in the register R₁.

The computed constants table 104 illustrated in FIGS. 2A and 2B includes multiple entries 208(0)-208(X). To facilitate caching of constant values, each entry 208(0)-208(X) of the computed constants table 104 includes a program counter (PC) field 210 and a value field 212. The program counter field 210 for each entry 208(0)-208(X) may be used to store the address 206 of the constant-generating instruction sequence 202 that is detected by the instruction processing circuit 102. The value field 212 may store a constant value generated by the constant-generating instruction sequence 202 associated with the address 206 in the program counter field 210.

The constant cache 132 shown in FIGS. 2A and 2B comprises entries 214(0)-214(Y). Each of the entries 214(0)-214(Y) includes a register field 216 and a value field 218. The register field 216 of each entry 214(0)-214(Y) indicates one of the registers 120 of FIG. 1 associated with the entry 214(0)-214(Y), while the value field 218 indicates a value most recently stored in the corresponding register 120. As discussed above, the constant cache 132 may provide a quick-access mechanism providing speedier access to cached values than loading the values directly from the registers 120. It is to be understood that some aspects may provide a communications pathway (not shown) for providing constant values to dependent instructions instead of or in addition to the constant cache 132.

Referring now to FIG. 2A, communications flows in some aspects for establishing an entry 208(X) in the computed constants table 104 are illustrated. As the instruction processing circuit 102 processes the instruction stream 200 for the first time, a first instance of the constant-generating instruction sequence 202 is detected. As indicated by arrow 220, the instruction processing circuit 102 checks the computed constants table 104 to determine whether the address 206 of the constant-generating instruction sequence 202 (i.e., the hexadecimal value 0x400) may be found in any of the entries 208(0)-208(X). In this example, the instruction processing circuit 102 does not find the address 206 in the entries 208(0)-208(X), and thus, in response to the “miss,” continues conventional processing of the constant-generating instruction sequence 202.

Upon execution of the constant-generating instruction sequence 202, the constant value (not shown) generated by the constant-generating instruction sequence 202 is forwarded to the dependent instruction 204 using conventional mechanisms, as indicated by arrow 222. The instruction processing circuit 102 then generates the entry 208(X) in the computed constants table 104 based on the constant value, as indicated by arrow 224. The address 206 of the constant-generating instruction sequence 202 is then stored in the program counter field 210 of the entry 208(X), while the constant value is stored in the value field 212 of the entry 208(X).

FIG. 2B illustrates the use of the entry 208(X) of the computed constants table 104 for providing a constant value 226 to the dependent instruction 204. As seen in FIG. 2B, the address 206 of the constant-generating instruction sequence 202 is stored in the program counter field 210 of the entry 208(X), while the constant value 226 generated by the constant-generating instruction sequence 202 is stored in the value field 212 of the entry 208(X). The instruction processing circuit 102 now processes the instruction stream 200 again, and detects a second instance of the constant-generating instruction sequence 202. As indicated by arrow 228, the instruction processing circuit 102 checks the computed constants table 104 to determine whether the address 206 is found in any of the entries 208(0)-208(X), and this time locates the entry 208(X).

In response, the instruction processing circuit 102 assigns the constant value 226 provided by the entry 208(X) to the entry 214(0) in the constant cache 132 corresponding to register R₀, as indicated by arrow 230. The constant value 226 is then provided to the dependent instruction 204 via the constant cache 132, as indicated by arrow 232. In this manner, the dependent instruction 204 is able to receive the constant value 226 while incurring a zero-cycle latency.

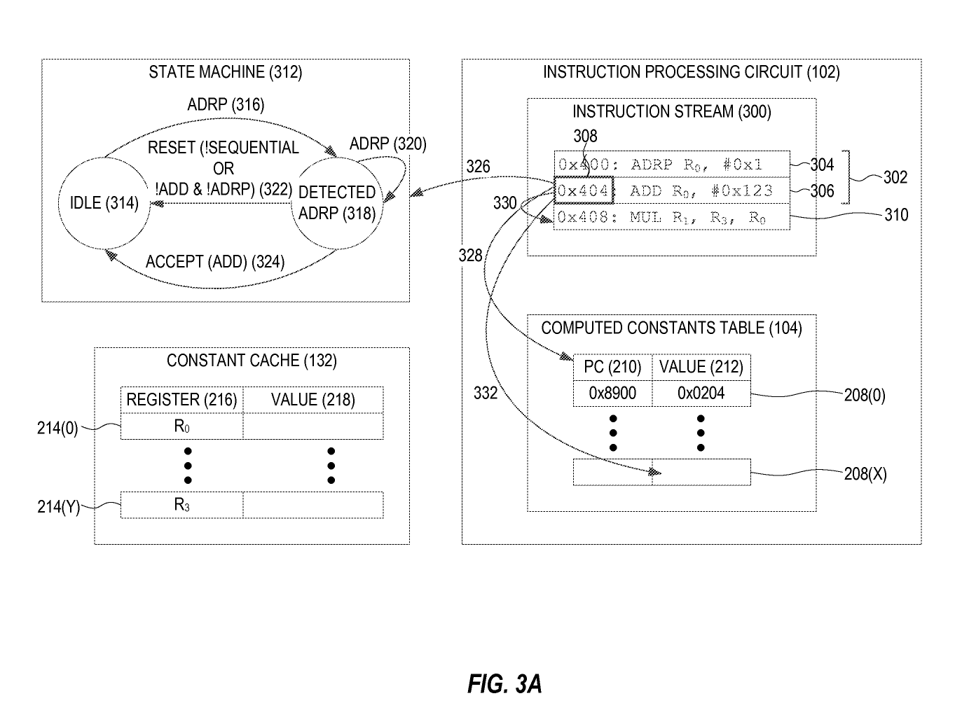

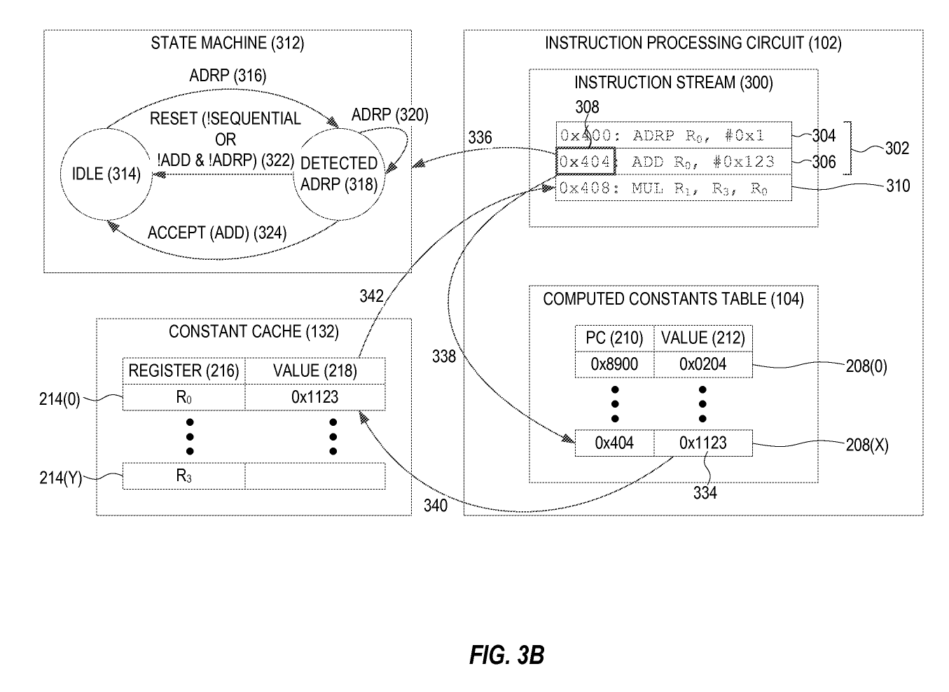

FIGS. 3A and 3B are provided to illustrate exemplary communications flows between the instruction processing circuit 102 and the constant cache 132 of FIG. 1 for generating and providing a constant value based on a plurality of constant-generating instructions. In FIG. 3A, exemplary communications flows for establishing an entry in the computed constants table 104 based on a plurality of constant-generating instructions are illustrated. FIG. 3B illustrates exemplary communications flows for providing a constant value of the entry to a dependent instruction. Elements of FIG. 1 are referenced in describing FIGS. 3A and 3B.

In FIGS. 3A and 3B, an instruction stream 300 being processed by the instruction processing circuit 102 includes a constant-generating instruction sequence 302 having a plurality of constant-generating instructions (in this example, a first instruction 304 and a last instruction 306). The constant-generating instruction sequence 302 is associated with an address 308, which is the hexadecimal value 0x404 corresponding to an address of the last instruction 306. According to some aspects, the address 308 may be retrieved from, e.g., the program counter 124 of FIG. 1. The instruction stream 300 also includes a dependent instruction 310 following the constant-generating instruction sequence 302. While the constant-generating instruction sequence 302 and the dependent instruction 310 of FIGS. 3A and 3B are shown as occurring consecutively within the instruction stream 300, in some aspects the constant-generating instruction sequence 302 and the dependent instruction 310 may be separated in the instruction stream 300 by intervening instructions (not shown).

The first instruction 304 of the constant-generating instruction sequence 302 in FIGS. 3A and 3B is an ADRP instruction. The ADRP instruction directs the computer processor 100 to load a constant value from an address specified by a current value of the program counter (PC) 124 plus the hexadecimal value 0x1 shifted leftward 12 times (i.e, 0x1<<12). The constant value is then stored in a register R₀, which may be one of the registers 120 of FIG. 1, as a non-limiting example. The last instruction 306 of the constant-generating instruction sequence 302 is an ADD instruction, which sums the hexadecimal value 0x123 with the value of the register R₀, and stores the result in the register R₀. The dependent instruction 310 in this example is a MUL instruction that multiplies the value of the register R₀ with a current value of a register R₁ (e.g., another one of the registers 120 of FIG. 1). The result is then stored in the register R₁.

FIGS. 3A and 3B also show the computed constants table 104 and the constant cache 132 as described above with respect to FIGS. 2A and 2B. In particular, the computed constants table 104 illustrated in FIGS. 3A and 3B includes multiple entries 208(0)-208(X), each having the program counter (PC) field 210 and the value field 212 similar to FIGS. 2A and 2B. Similarly, the constant cache 132 of FIGS. 3A and 3B provides the entries 214(0)-214(Y) including the register field 216 and the value field 218.

In the example of FIGS. 3A and 3B, the instruction processing circuit 102 employs a state machine 312 to detect instances of the constant-generating instruction sequence 302 in the instruction stream 300. As each instruction 304, 306 is fetched, the instruction processing circuit 102 updates the state machine 312 and determines what action, if any, to take. The state machine 312 begins in a state IDLE 314. As the instruction stream 300 is processed by the instruction processing circuit 102, the state machine 312 remains in the state IDLE 314 until an ADRP instruction, such as the first instruction 304, is detected. This triggers a transition ADRP 316 into a state DETECTED ADRP 318. The state machine 312 then remains in the state DETECTED ADRP 318 as the instruction stream 300 is further processed.

If another ADRP instruction is detected next in the instruction stream 300, the state machine 312 undergoes a transition ADRP 320, which returns the state machine 312 back to the state DETECTED ADRP 318. If an instruction that causes program flow to be redirected is encountered, or if the next instruction encountered in the instruction stream 300 is neither an ADD instruction nor an ADRP instruction, a transition RESET 322 is triggered back to the state IDLE 314. Finally, if the next instruction detected in the instruction stream 300 is an ADD instruction such as the last instruction 306, a transition ACCEPT 324 is triggered, and the state machine 312 moves back to the state IDLE 314. An occurrence of the transition ACCEPT 324 indicates to the instruction processing circuit 102 that the constant-generating instruction sequence 302 has been detected in the instruction processing circuit 102. It is to be understood that that the state machine 312 is a non-limiting example of logic that may be employed to detect instances of the constant-generating instruction sequence 302 in the instruction stream 300. In some aspects, the instruction processing circuit 102 may employ additional and/or other state machines 312 configured to detect other constant-generating instruction sequences in addition to or instead of the constant-generating instruction sequence 302 of FIGS. 3A and 3B.

Referring now to FIG. 3A, communications flows in some aspects for establishing an entry 208(X) in the computed constants table 104 based on a plurality of constant-generating instructions 304, 306 are illustrated. As the instruction processing circuit 102 processes the instruction stream 300 for the first time, a first instance of the constant-generating instruction sequence 302 is detected using the state machine 312, as indicated by arrow 326. The instruction processing circuit 102 then checks the computed constants table 104 to determine whether the address 308 of the constant-generating instruction sequence 302 (i.e., the hexadecimal value 0x404 corresponding to an address of the last instruction 306) may be found in any of the entries 208(0)-208(X), as shown by arrow 328. In this example, the instruction processing circuit 102 does not find the address 308 in the entries 208(0)-208(X), so conventional processing of the constant-generating instruction sequence 302 continues.

After the constant-generating instruction sequence 302 has executed, the constant value (not shown) generated by the constant-generating instruction sequence 302 is forwarded to the dependent instruction 310 using conventional mechanisms, as indicated by arrow 330. The instruction processing circuit 102 then generates the entry 208(X) in the computed constants table 104 based on the constant value, as indicated by arrow 332. The address 308 of the constant-generating instruction sequence 302 is stored in the program counter (PC) field 210 of the entry 208(X), while the constant value is stored as a constant value in the value field 212 of the entry 208(X).

In FIG. 3B, the use of the entry 208(X) of the computed constants table 104 for providing a constant value 334 to the dependent instruction 310 is illustrated. In the example of FIG. 3B, the address 308 of the last instruction 306 of the constant-generating instruction sequence 302 is stored in the program counter (PC) field 210 of the entry 208(X), while the constant value 334 is stored in the value field 212 of the entry 208(X). The instruction processing circuit 102 now processes the instruction stream 300 again, and uses the state machine 312 to detect a second instance of the constant-generating instruction sequence 302, as indicated by arrow 336. As shown by arrow 338, the instruction processing circuit 102 checks the computed constants table 104 to determine whether the address 308 is found in any of the entries 208(0)-208(X), and locates the address 308 in the entry 208(X).

In response, the instruction processing circuit 102 assigns the constant value 334 provided by the entry 208(X) to the entry 214(0) in the constant cache 132 corresponding to register R₀, as indicated by arrow 340. The constant value 334 is then provided to the dependent instruction 310 via the constant cache 132, as indicated by arrow 342. The dependent instruction 310 is thus able to receive the constant value 334 while incurring a zero-cycle latency.

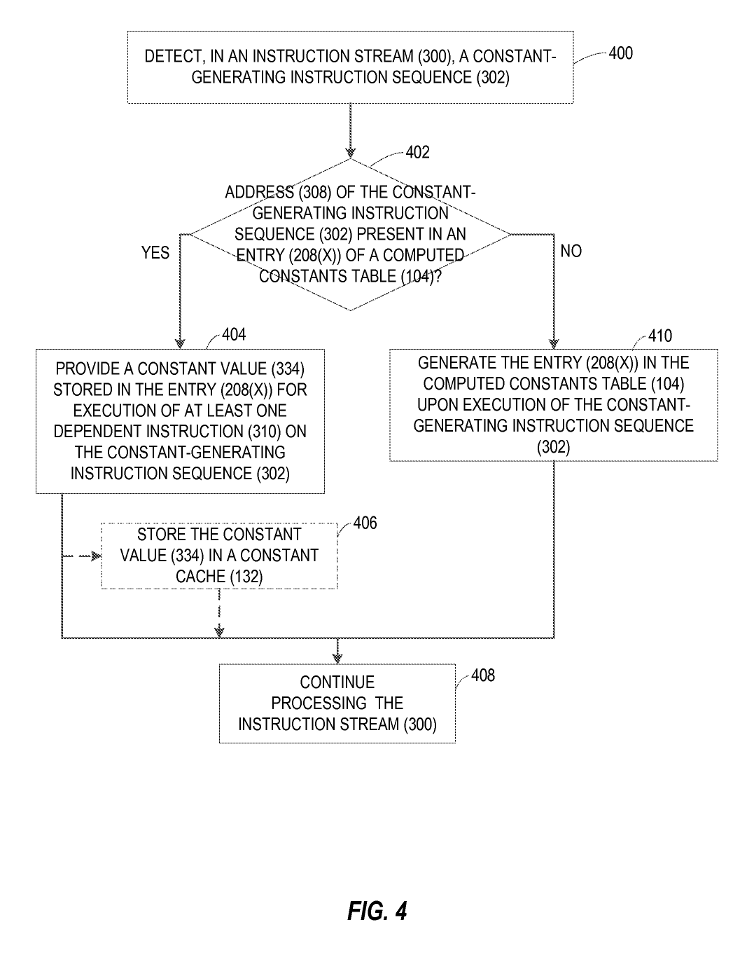

FIG. 4 is a flowchart illustrating exemplary operations for accelerating constant value generation using the computed constants table 104 of FIG. 1. For the sake of clarity, elements of FIGS. 1, 3A, and 3B are referenced in describing FIG. 4. Operations in FIG. 4 begin with the instruction processing circuit 102 of FIG. 1 detecting, in the instruction stream 300, a constant-generating instruction sequence 302 (block 400). Detecting the constant-generating instruction sequence 302 may be accomplished by, for example, using a state machine such as the state machine 312 of FIGS. 3A and 3B.

The instruction processing circuit 102 next determines whether the address 308 of the constant-generating instruction sequence 302 is present in an entry 208(X) of the computed constants table 104 (block 402). If so, the instruction processing circuit 102 provides a constant value 334 stored in the entry 208(X) for execution of at least one dependent instruction 310 on the constant-generating instruction sequence 302 (block 404). In some aspects, operations of block 404 for providing the constant value 334 may include storing the constant value 334 in the constant cache 132 (block 406). In this manner, the at least one dependent instruction 310 thus may receive the constant value 334 while incurring a zero-cycle latency. The instruction processing circuit 102 then continues processing the instruction stream 300 (block 408).

If, at decision block 402, the instruction processing circuit 102 determines that the address 308 of the constant-generating instruction sequence 302 is not present in an entry 208(X) of the computed constants table 104, the instruction processing circuit 102 generates the entry 208(X) in the computed constants table 104 (block 410). In some aspects, the entry 208(X) is generated upon execution of the constant-generating instruction sequence 302, and stores the address 308 of the constant-generating instruction sequence 302 and the constant value 334 generated by the constant-generating instruction sequence 302. The instruction processing circuit 102 then continues processing the instruction stream 300 (block 408).

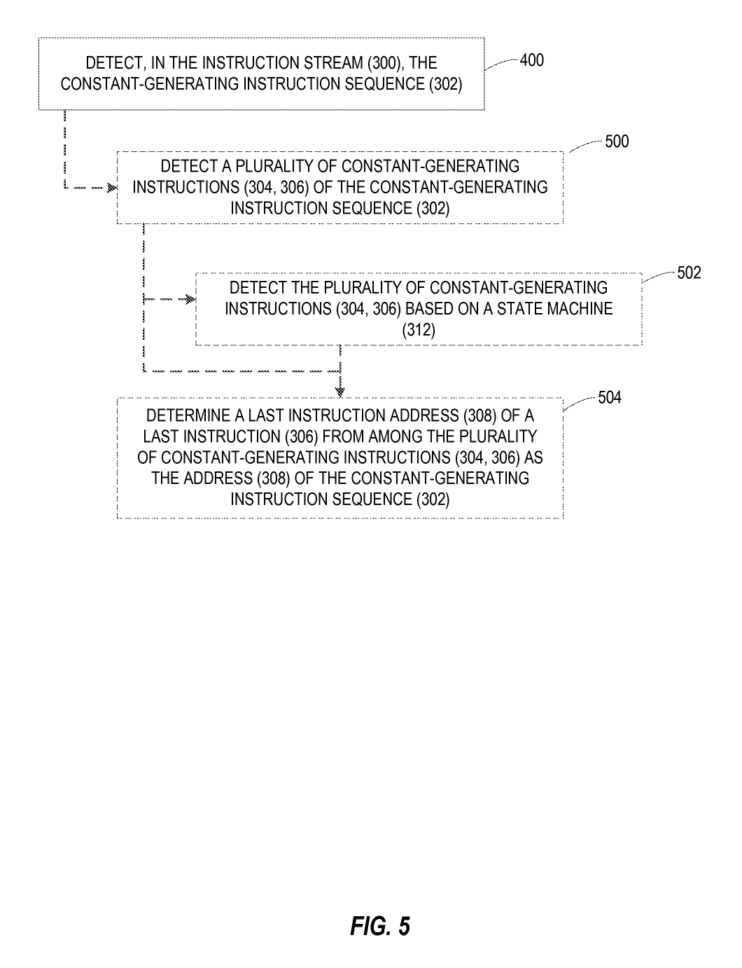

FIG. 5 is provided to further illustrate exemplary operations for detecting the constant-generating instruction sequence 302 in the instruction stream 300 of FIGS. 3A and 3B in some aspects. Elements of FIGS. 1, 3A, and 3B are referenced in describing FIG. 5 for the sake of clarity. It is to be understood that the exemplary operations illustrated in FIG. 5 may correspond to the operations of block 400 illustrated in FIG. 4.

As seen in FIG. 5, the instruction processing circuit 102 may detect, in the instruction stream 300, the constant-generating instruction sequence 302 (block 400). According to some aspects disclosed herein, detecting the constant-generating instruction sequence 302 may include detecting the plurality of constant-generating instructions 304, 306 of the constant-generating instruction sequence 302 (block 500). In some aspects, detecting the plurality of constant-generating instructions 304, 306 may comprise detecting the plurality of constant-generating instructions 304, 306 based on a state machine 312 (block 502). After detecting the plurality of constant-generating instructions 304, 306, the instruction processing circuit 102 may determine a last instruction address 308 of the last instruction 306 from among the plurality of constant-generating instructions 304, 306 as the address 308 of the constant-generating instruction sequence 302 (block 504).

Accelerating constant value generation using a computed constants table according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

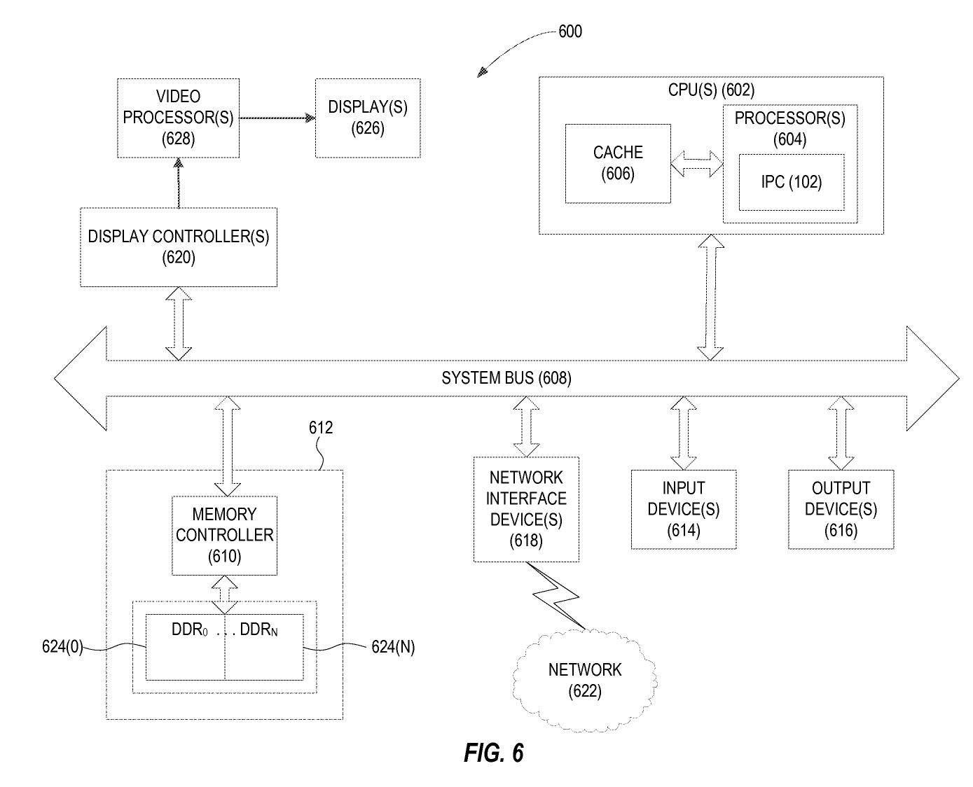

In this regard, FIG. 6 illustrates an example of a processor-based system 600 that can employ the instruction processing circuit 102 illustrated in FIGS. 1, 2A, 2B, 3A, and 3B. In this example, the processor-based system 600 includes one or more central processing units (CPUs) 602, each including one or more processors 604. The one or more processors 604 may include the instruction processing circuit (IPC) 102 of FIGS. 1, 2A, 2B, 3A, and 3B. The CPU(s) 602 may be a master device. The CPU(s) 602 may have cache memory 606 coupled to the processor(s) 604 for rapid access to temporarily stored data. The CPU(s) 602 is coupled to a system bus 608 and can intercouple master and slave devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including but not limited to audio, video, other visual indicators, etc. The network interface device(s) 618 can be any devices configured to allow exchange of data to and from a network 622. The network 622 can be any type of network, including but not limited to a wired or wireless network, a private or public network, a local area network (LAN), a wide local area network (WLAN), and the Internet. The network interface device(s) 618 can be configured to support any type of communications protocol desired. The memory system 612 can include one or more memory units 624(0-N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sets other than the illustrated sets. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An instruction processing circuit configured to:
detect, in an instruction stream, a constant-generating instruction sequence;
determine whether an address of the constant-generating instruction sequence is present in an entry of a computed constants table; and
responsive to determining that the address of the constant-generating instruction sequence is present in the entry of the computed constants table, provide a constant value stored in the entry for execution of at least one dependent instruction on the constant-generating instruction sequence.

2. The instruction processing circuit of claim 1, configured to detect the constant-generating instruction sequence by:
detecting a plurality of constant-generating instructions of the constant-generating instruction sequence; and
determining a last instruction address of a last instruction from among the plurality of constant-generating instructions as the address of the constant-generating instruction sequence.

3. The instruction processing circuit of claim 2, configured to detect the plurality of constant-generating instructions based on a state machine.

4. The instruction processing circuit of claim 2, configured to detect the plurality of constant-generating instructions by locating a predetermined set of arithmetic logic unit (ALU) operations.

5. The instruction processing circuit of claim 1, further configured to:
responsive to determining that the address of the constant-generating instruction sequence is not present in the entry of the computed constants table, generate the entry in the computed constants table upon execution of the constant-generating instruction sequence.

6. The instruction processing circuit of claim 1, configured to provide the constant value stored in the entry for execution of the at least one dependent instruction by storing the constant value in a constant cache.

7. The instruction processing circuit of claim 1 integrated into an integrated circuit (IC).

8. The instruction processing circuit of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

9. A method of accelerating generation of constant values, comprising:
detecting, in an instruction stream, a constant-generating instruction sequence;
determining whether an address of the constant-generating instruction sequence is present in an entry of a computed constants table; and
responsive to determining that the address of the constant-generating instruction sequence is present in the entry of the computed constants table, providing a constant value stored in the entry for execution of at least one dependent instruction on the constant-generating instruction sequence.

10. The method of claim 9, wherein detecting the constant-generating instruction sequence comprises:
detecting a plurality of constant-generating instructions of the constant-generating instruction sequence; and
determining a last instruction address of a last instruction from among the plurality of constant-generating instructions as the address of the constant-generating instruction sequence.

11. The method of claim 10, wherein detecting the plurality of constant-generating instructions is based on a state machine.

12. The method of claim 10, wherein the constant-generating instruction sequence comprises a predetermined set of arithmetic logic unit (ALU) operations.

13. The method of claim 9, further comprising:
responsive to determining that the address of the constant-generating instruction sequence is not present in the entry of the computed constants table, generating the entry in the computed constants table upon execution of the constant-generating instruction sequence.

14. The method of claim 9, wherein providing the constant value stored in the entry for execution of the at least one dependent instruction comprises storing the constant value in a constant cache.

15. A non-transitory computer-readable medium having stored thereon computer-executable instructions to cause a processor to:
detect, in an instruction stream, a constant-generating instruction sequence;
determine whether an address of the constant-generating instruction sequence is present in an entry of a computed constants table; and
responsive to determining that the address of the constant-generating instruction sequence is present in the entry of the computed constants table, provide a constant value stored in the entry for execution of at least one dependent instruction on the constant-generating instruction sequence.

16. The non-transitory computer-readable medium of claim 15 having stored thereon computer-executable instructions to further cause the processor to detect the constant-generating instruction sequence by:
detecting a plurality of constant-generating instructions of the constant-generating instruction sequence; and
determining a last instruction address of a last instruction from among the plurality of constant-generating instructions as the address of the constant-generating instruction sequence.

17. The non-transitory computer-readable medium of claim 16 having stored thereon computer-executable instructions to further cause the processor to detect the plurality of constant-generating instructions based on a state machine.

18. The non-transitory computer-readable medium of claim 16 having stored thereon computer-executable instructions to further cause the processor to detect the plurality of constant-generating instructions by locating a predetermined set of arithmetic logic unit (ALU) operations.

19. The non-transitory computer-readable medium of claim 15 having stored thereon computer-executable instructions to further cause the processor to:
responsive to determining that the address of the constant-generating instruction sequence is not present in the entry of the computed constants table, generate the entry in the computed constants table upon execution of the constant-generating instruction sequence.

20. The non-transitory computer-readable medium of claim 15 having stored thereon computer-executable instructions to further cause the processor to provide the constant value stored in the entry for execution of the at least one dependent instruction by storing the constant value in a constant cache.
